(19) United States
(12) Patent Application Publication
(10) Pub. No.: US 2013/0045717 A1
(43) Pub. Date: Feb. 21, 2013

(54) Multimedia Message Saving Method and Mobile Terminal

(71) Applicant: Gang Cao, Shenzhen (CN)

(72) Inventor: Gang Cao, Shenzhen (CN)

(73) Assignee: ZTE CORPORATION, Shenzhen, Guangdong (CN)

(21) Appl. No.: 13/695,174

(22) PCT Filed: Jul. 20, 2010
(86) PCT No.: PCT/CN2010/075302

§ 371 Date: Oct. 29, 2012

(30) Foreign Application Priority Data
May 5, 2010 (CN) 201010168822.2

(51) Int. Cl. H04W 4/12

(52) U.S. Cl. 455/412.1

(57) ABSTRACT

The disclosure provides a Multimedia Message (MM) saving method, which includes: extracting a destination MM page to a temporary folder of a mobile terminal; obtaining a saving category of the destination MM page; editing the destination MM page in the temporary folder of the mobile terminal as a MM in the saving category; and saving the edited MM. The disclosure further discloses a mobile terminal. By extracting the destination MM page, a mobile terminal user does not need to save all the MM pages of the MM, but can save the MM pages he/she likes by classification in the limited storage space of the mobile terminal, and recombine them into a new MM.

### TECHNICAL FIELD

The disclosure relates to the field of communication of the mobile terminals, in particular to a Multimedia Message (MM) saving method and a mobile terminal.

### BACKGROUND

The Multimedia Messaging Service (MMS) is the one developed with the highest standard among the existing short messaging service technology, and is most characterized by supporting a multimedia function, it transmits video clip, picture, voice and text between mobile terminals as well as between a mobile terminal and a computer by adopting high speed transmission technology (i.e. the Enhanced Data Rate For GSM Evolution (EDGE)) and the General Packet Radio Service (GPRS) technology, with the Wireless Application Protocol (WAP) as a carrier.

At present, the widely used MMS is the mobile news service, which is a value added service operated through cooperation between the mobile operator and domestic mainstream media, so as to provide timely information service for a client, such as current affairs, weather forecast, health guide or financial information, with the MMS as the primary browsing way and the WAP as the secondary browsing way. The client can view the abovementioned information at any time through the browsing function of the MMS. However, there are always the following problems when a user uses the mobile news: since the mobile news has abundant information and a large amount of data, when a user wants to save a Multimedia Message (MM) page of the mobile news he/she is interested in, he/she has to save all MM pages and cannot only save an certain MM page in the mobile news; and common MMS also has such problems.

### SUMMARY

The main objective of the disclosure is to provide an Multimedia Message (MM) saving method and a mobile terminal, to enable a user of saving an MM page which he/she is interested in by classification.

The MM saving method includes:
extracting a destination MM page to a temporary folder of the mobile terminal;
obtaining a saving category of the destination MM page;
editing the destination MM page in the temporary folder of the mobile terminal as a MM in the saving category; and
saving the edited MM.

Before the destination MM page is extracted to the temporary folder of the mobile terminal, the method further includes:
clearing the temporary folder of the mobile terminal.

The saving category may be an existing saving category or a new saving category.

The saving category may be identified by a title of the MM.

The editing of the destination MM page in the temporary folder of the mobile terminal as a MM in the saving category may include:
when the saving category is an existing saving category, recoding the destination MM page in the temporary folder of the mobile terminal and a MM in a selected saving category as a new MM; or
when the saving category is a new saving category, establishing the destination MM page in the temporary folder of the mobile terminal as a MM in the new saving category.

A mobile terminal includes:
an MM page extracting module, configured to extract a destination MM page to a temporary folder of the mobile terminal;
an MM page selecting module, configured to obtain a saving category of the destination MM page; and
an MM page convergence module, configured to edit the destination MM page in the temporary folder of the mobile terminal as a MM in the saving category and to save the edited MM.

The mobile terminal further includes:
a clearing module, configured to clear the temporary folder of the mobile terminal when the temporary folder of the mobile terminal is not empty, before the MM page extracting module extracts the destination MM page to the temporary folder of the mobile terminal.

The saving category may be an existing saving category or a new saving category.

The saving category may be identified by a title of the MM.

The MM page convergence module may include:
a selecting convergence sub-module, configured to recode the destination MM page in the temporary folder of the mobile terminal and a MM in a selected saving category as a new MM, when the saving category is an existing saving category; or
a creating convergence sub-module configured to establish the destination MM page in the temporary folder of the mobile terminal as a MM in the new saving category when the saving category is a new saving category.
In the MM saving method and the mobile terminal, by extracting the destination MM page, a mobile terminal user does not need to save all the MM pages of the MM, but can save an MM page he/she likes by classification in the limited storage space of the mobile terminal, and recombine them into a new MM.

### BRIEF DESCRIPTION OF THE DRAWINGS

FIG. 1 is a flowchart of an MM saving method according to an embodiment of the disclosure;

FIG. 2 is a diagram showing the structure of a mobile terminal according to an embodiment of the disclosure;

FIG. 3 is a diagram showing the structure of an MM page convergence module of a mobile terminal according to an embodiment of the disclosure.

### DETAILED DESCRIPTION

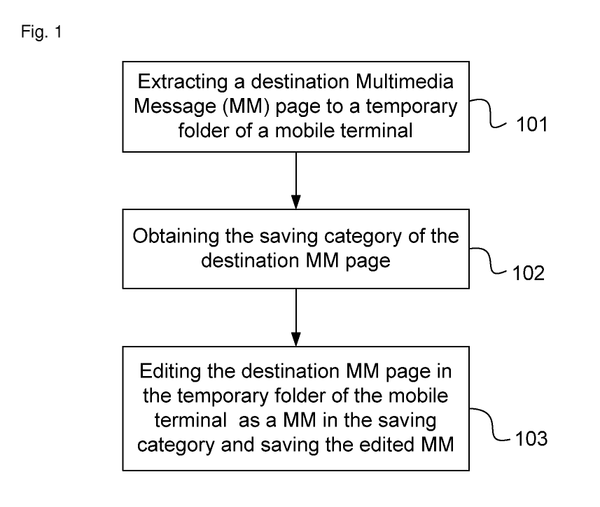

FIG. 1 is a flowchart of an MM saving method according to an embodiment of the disclosure, as shown in FIG. 1, the method includes:

Step S101: extracting a destination MM page to a temporary folder of the mobile terminal, which includes:
firstly, selecting the destination MM page; then, detecting whether the temporary folder of the mobile terminal used for saving the destination MM page is empty, and clearing the temporary folder when the temporary folder is not empty; and finally, copying the destination MM page to the temporary folder of the mobile terminal.

The mobile news received by the mobile terminal user generally includes abundant contents, such as sports, current affairs and weather forecast, and consists of multiple MM pages; if the mobile terminal user wants to only save the contents he/she is interested in, such as sports, when browsing the mobile news, he/she may make a copy in the MM page where the sports contents are located and extracts the MM page to the temporary folder of the mobile terminal. Before the MM page is extracted, the mobile terminal will detect whether the temporary folder of the mobile terminal is empty, when the temporary folder is not empty, the temporary folder of the mobile terminal is cleared so that the destination MM page can be saved. Meanwhile, the parameters including the corresponding paths of the resource files, such as video, text and/or picture, in the destination MM page in the temporary folder of the mobile terminal, and the playing time of the MM page, are extracted to a temporary area to be used in step S103.

Step S102: obtaining the saving category of the destination MM page; which includes:
at first, traversing the MMs existed in the mobile terminal to obtain the saving categories of the MMs existed; then, displaying all the saving categories to the mobile terminal user in a list form and prompting the mobile terminal user to select or create a saving category; and finally, recording the saving category selected or created by the mobile terminal user.

After extracting the destination MM page, the mobile terminal traverses the MMs originally saved by the mobile terminal user; the existed MMs are saved in the file system of the mobile terminal by classification, such as sports, current affairs and/or weather forecast; the saving categories are generally the title contents of various MMs and are saved in the fields of the MMs as MM headers; the MM headers of the MMs are analyzed and all the saving categories of the existed MMs are obtained; and all the saving categories are displayed to the mobile terminal user in a list form to prompt the mobile terminal user to select or create a saving category. After the selection or creation of the mobile terminal user, the mobile terminal records the saving category selected or created by the mobile terminal user.

Step S103: editing the destination MM page in the temporary folder of the mobile terminal as a MM in the saving category and saving the edited MM, which includes:
when the saving category is an existing saving category, recoding the destination MM page in the temporary folder of the mobile terminal and a MM in a selected saving category as a new MM; or
when the saving category is a new saving category, establishing the destination MM page in the temporary folder of the mobile terminal as a MM in the new saving category.

When the mobile terminal user selects a existed saving category, the mobile terminal recodes the destination MM page in the temporary folder of the mobile terminal and the MM in the selected saving category as a new MM and saves the new MM to the file system of the mobile terminal, which actually includes the following three steps:
A: extracting the parameters including the corresponding paths of the resource files and the playing time of the MM in the saving category selected by the mobile terminal user from the file system of the mobile terminal into a temporary list.
B: inserting the parameters including the corresponding paths of the resource files of the destination MM page and the playing time of the MM page extracted in S101 into the temporary list to be behind the data saved in step A.
C: recoding, according to the parameters including the paths of the resource files and the playing time in the upgraded temporary list, the destination MM page data in the temporary folder of the mobile terminal and the originally existed MM data in the saving category selected by the mobile terminal user according to the parameters including the paths of the resource files and the playing time in the upgraded temporary list, and then saving the recoded MM into the file system of the mobile terminal.

The abovementioned process is called the edition of the MM to generate a new MM; the saving category selected by the mobile terminal user is the MM header of the new MM and is generally identified by the title of the MM so as to complete the convergence of the MM page. If the saving category required by the mobile terminal user does not exist in the existed saving categories, for example, the title contents of the MM page that the mobile terminal user needs to save is entertainment, but only sports, current affairs and weather forecast are in the exited saving categories of the MMs of the mobile terminal, the mobile terminal user may create an entertainment saving category; when the mobile terminal user creates a saving category, the destination MM page in the temporary folder of the mobile terminal is established as a MM of a new category and is saved to the file system of the mobile terminal; and the new saving category is taken as the MM header of the MM to complete the convergence of the MM page.

By adopting the MM saving method, a mobile terminal user can only save the MM page he/she likes by classification in the limited storage space of the mobile terminal.

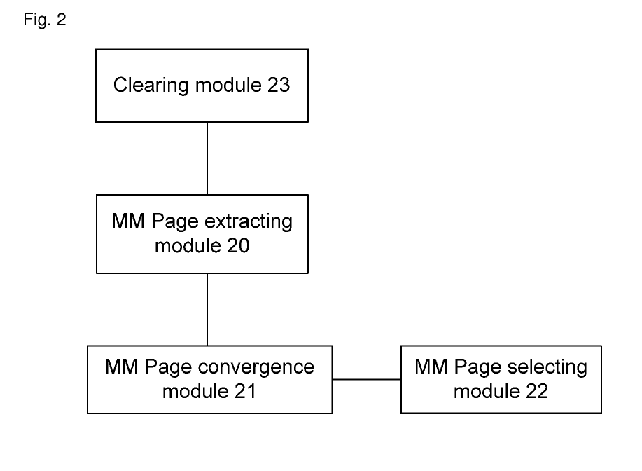

FIG. 2 is a diagram showing the composition structure of a mobile terminal according to an embodiment of the disclosure, as shown in FIG. 2, and the mobile terminal at least includes:
an MM page extracting module 20, configured to extract a destination MM page to a temporary folder of the mobile terminal;
an MM page selecting module 22, configured to obtain a saving category of the destination MM page; and
an MM page convergence module 21, configured to edit the destination MM page in the temporary folder of the mobile terminal as a MM in the saving category and to save the edited MM.

The mobile terminal further includes a clearing module 23, configured to clear the temporary folder of the mobile terminal when the temporary folder of the mobile terminal is not empty, before the MM page extracting module 20 extracts the destination MM page to the temporary folder of the mobile terminal.

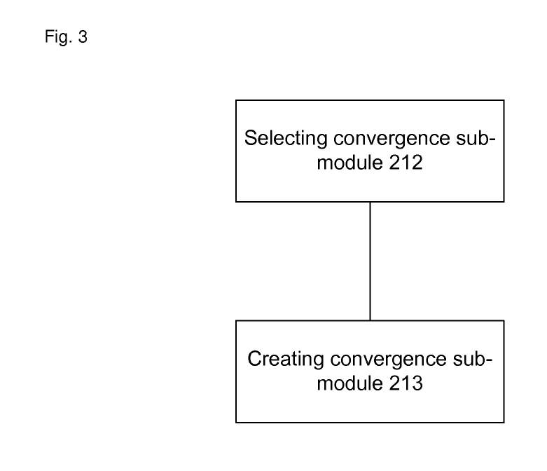

FIG. 3 is a diagram showing the composition structure of an MM page convergence module 21 according to an embodiment of the disclosure, as shown in FIG. 3, and the MM page convergence module 21 mainly includes:
a selecting convergence sub-module 212, configured to recode the destination MM page in the temporary folder of the mobile terminal and a MM in a selected saving category as a new MM, when the saving category is an existing saving category; or
a creating convergence sub-module 213, configured to establish the destination MM page in the temporary folder of the mobile terminal as a MM in the new saving category, when the saving category is a new saving category.

The mobile news received by the mobile terminal user generally includes abundant contents, such as sports, current affairs and weather forecast, and consists of multiple MM pages; if the mobile terminal user wants to only save the contents he/she is interested in, such as sports, when browsing the mobile news, he/she may make a copy in the MM page where the sports contents are located, at the moment, the MM page extracting module 20 of the mobile terminal extracts the MM page to the temporary folder of the mobile terminal. Before the MM page is extracted, the clearing module 23 will detect whether the temporary folder of the mobile terminal is empty, when the temporary folder is not empty, the clearing module 23 clears the temporary folder of the mobile terminal in order to save the destination MM page. Meanwhile, the parameters including the corresponding paths of the resource files, such as video, text and/or picture, in the destination MM page in the temporary folder of the mobile terminal, and the playing time of the MM page, are extracted to a temporary area to be used by the MM page convergence module 21.

After the MM page extracting module 20 extracts the destination MM page, the MM page selecting module 22 traverses the MMs originally saved by the mobile terminal user; the existed MMs are saved in the file system of the mobile terminal by classification, such as sports, current affairs and/or weather forecast; the saving categories are generally the title contents of various MMs and are saved in the fields of the MMs as MM headers; the MM page selecting module 22 analysis the MM headers of the MMs and obtain all the saving categories of the existed MMs ; and all the saving categories are displayed to the mobile terminal user in a list form to prompt the mobile terminal user to select or create a saving category. After the selection or creation of the mobile terminal user, the MM page selecting module 22 records the saving category selected or created by the mobile terminal user.

When the mobile terminal user selects a existed saving category, the selecting convergence sub-module 212 re-edits the destination MM page in the temporary folder of the mobile terminal and the MM in the saving category recorded by the MM page selecting module 22 as a new MM, which includes:
firstly, extracting the parameters including the corresponding paths of the resource files and playing time of the MMs in the saving category selected by the mobile terminal user from the file system of the mobile terminal into a temporary list; then, saving the parameters including the corresponding paths of the resource files and playing time of the destination MM page extracted by the MM page extracting module 20 into the temporary list, through inserting the parameters to be behind the parameters including the corresponding paths of the resource files and playing time of the MMs in the saving category selected by the mobile terminal user; and finally, recoding the destination MM page data in the temporary folder of the mobile terminal and the originally existed MM data in the saving category selected by the mobile terminal user according to the parameters including the paths of the resource files and playing time in the upgraded temporary list, and then saving the recoded MM into the file system of the mobile terminal.

The abovementioned process is called the edition of the MM to generate a new MM; the saving category selected by the mobile terminal user is the MM header of the new MM for completing the convergence of the MM page. If the saving category required by the mobile terminal user does not exist in the existed saving categories, for example, the title contents of the MM page that the mobile terminal user needs to save is entertainments, but only sports, current affairs and weather forecast are in the existed saving categories of the MMs of the mobile terminal, so the mobile terminal user may create an entertainment saving category; the creating convergence sub-module 213 establishes the destination MM page in the temporary folder of the mobile terminal as a MM of a new category according to the new saving category recorded by the MM page selecting module 22; and the new saving category is taken as the MM header of the MM, for completing the convergence of the MM page.

By using the mobile terminal, a mobile terminal user can only save the MM page he/she likes by classification in the limited storage space of the mobile terminal.

What described above are only preferred embodiments of the present invention, and not intended to limit the patent scope of the disclosure; and all the changes of the equivalent structure or equivalent flow made by using the description and drawings of the disclosure, or directly or indirectly application to other related technical fields are for the same reason included in the patent protection scope of the disclosure.

1. A Multimedia Message (MM) saving method, comprising:
extracting a destination MM page to a temporary folder of a mobile terminal;
obtaining a saving category of the destination MM page;
editing the destination MM page in the temporary folder of the mobile terminal as a MM in the saving category; and
saving the edited MM.

2. The MM saving method according to claim 1, further comprising:
before the destination MM page is extracted to the temporary folder of the mobile terminal,
clearing the temporary folder of the mobile terminal.

3. The MM saving method according to claim 1, wherein the saving category is an existing saving category or a new saving category.

4. The MM saving method according to claim 3, wherein the saving category is identified by a title of the MM.

5. The MM saving method according to claim 1, wherein the editing the destination MM page in the temporary folder of the mobile terminal as a MM in the saving category comprises:
when the saving category is an existing saving category, recoding the destination MM page in the temporary folder of the mobile terminal and a MM in a selected saving category as a new MM; or
when the saving category is a new saving category, establishing the destination MM page in the temporary folder of the mobile terminal as a MM in the new saving category.

6. A mobile terminal, comprising:
an Multimedia Message (MM) page extracting module, configured to extract a destination MM page to a temporary folder of the mobile terminal;
an MM page selecting module, configured to obtain a saving category of the destination MM page; and
an MM page convergence module, configured to edit the destination MM page in the temporary folder of the mobile terminal as a MM in the saving category and to save the edited MM.

7. The mobile terminal according to claim 6, further comprising:
a clearing module, configured to clear the temporary folder of the mobile terminal when the temporary folder of the mobile terminal is not empty, before the MM page extracting module extracts the destination MM page to the temporary folder of the mobile terminal.

8. The mobile terminal according to claim 6, wherein the saving category is an existing saving category or a new saving category.

9. The mobile terminal according to claim 8, wherein the saving category is identified by a title of the MM.

10. The mobile terminal according to claim 6, the MM page convergence module comprises:
a selecting convergence sub-module, configured to recode the destination MM page in the temporary folder of the mobile terminal and a MM in a selected saving category as a new MM, when the saving category is an existing saving category; or
a creating convergence sub-module, configured to establish the destination MM page in the temporary folder of the mobile terminal as a MM in the new saving category, when the saving category is a new saving category.

11. The MM saving method according to claim 2, wherein the saving category is an existing saving category or a new saving category.

12. The MM saving method according to claim 11, wherein the saving category is identified by a title of the MM.

13. The MM saving method according to claim 2, wherein the editing the destination MM page in the temporary folder of the mobile terminal as a MM in the saving category comprises:
when the saving category is an existing saving category, recoding the destination MM page in the temporary folder of the mobile terminal and a MM in a selected saving category as a new MM; or
when the saving category is a new saving category, establishing the destination MM page in the temporary folder of the mobile terminal as a MM in the new saving category.

14. The mobile terminal according to claim 7, wherein the saving category is an existing saving category or a new saving category.

15. The mobile terminal according to claim 14, wherein the saving category is identified by a title of the MM.

16. The mobile terminal according to claim 7, the MM page convergence module comprises:
a selecting convergence sub-module, configured to recode the destination MM page in the temporary folder of the mobile terminal and a MM in a selected saving category as a new MM, when the saving category is an existing saving category; or
a creating convergence sub-module, configured to establish the destination MM page in the temporary folder of the mobile terminal as a MM in the new saving category, when the saving category is a new saving category.
